(19) United States
(12) Patent Application Publication
(10) Pub. No.: US 2006/0206266 A1
(43) Pub. Date: Sep. 14, 2006

(54) Fixing device of satellite navigator

(76) Inventors: Kuo-Lung Tseng, Hsinchu (TW); Yi-Chih Liu, Hsinchu (TW); Yung-Chang Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/076,959

(22) Filed: Mar. 11, 2005

(51) Int. Cl. G01C 21/28

(52) U.S. Cl. 701/213

(57) ABSTRACT

A fixing device of a satellite navigator has a base connected to a car charger in a car. A public-address device is disposed in the base. Electric power is provided for the public-address device by the car charger. A supporting arm is disposed on the base. This supporting arm is of segmental design. A bearing seat is disposed at one end of the supporting arm for placement of a satellite navigator. The satellite navigator makes use of the public-address device to give traffic navigation instructions. The bearing seat is electrically connected with the car charger device so that the satellite navigator can be charged when placed on the bearing seat. The fixing device can amplify voice instructions for traffic navigation of the satellite navigator, and can fix the satellite navigator at any place in a car.

### BACKGROUND OF THE INVENTION

1. Field of the Invention

The present invention relates to a fixing device of a satellite navigator and, more particularly, to a multi-functional fixing device of a satellite navigator.

2. Description of Related Art

If one has never been to the destination when driving a car, he may suffer much trouble in finding the route. Nowadays, many people still have maps in their cars for finding the route in case when he got lost. This way of finding the route, however, is very inconvenient. Because there are sites depicted on a map, it usually takes much time finding where one is and the destination on the map.

Therefore, a car satellite navigator has been proposed. The car satellite navigator is usually a handheld system that can be taken off from a car. When one buys a car satellite navigator, a fixing device is generally attached to it so that the driver can fix the car satellite navigator in a car. As shown in FIG. 1, A fixing device 1 of a car satellite navigator has a base 10. The base 10 is connected to a snake pipe 12. A claw-shaped bearing seat 14 is disposed at one end of the snake pipe 12 for placement of the satellite navigator 2. This fixing device 1 of the satellite navigator 2 has only the fixing function. Moreover, the satellite navigator 1 makes use of its own beeper 20 to give traffic navigation instructions. When there are other sounds in the car, the traffic navigation instructions may be not discriminated clearly. When the satellite navigator 2 is placed on the bearing seat 14, it is still necessary to connect a car charger 3 for charging. When one wants to get off the car and take the satellite navigator 2 with him, it is still necessary to the car charger 3, resulting in much inconvenience in use.

Accordingly, the present invention aims to propose a fixing device of a satellite navigator to solve the above problems in the prior art.

### SUMMARY OF THE INVENTION

An object of the present invention is to provide a fixing device of a satellite navigator, which has a base with a public-address device disposed therein. The satellite navigator makes use of the public-address device to give traffic navigation instructions. Therefore, the problem of too small sound occurred when a beeper of the conventional satellite navigator is used to give instructions in the prior art can be solved.

Another object of the present invention is to provide a fixing device of a satellite navigator, which has a supporting arm of segmental design. This supporting arm can be used for angle adjustment to arbitrarily fix the satellite navigator placed on a bearing seat at any place.

Yet another object of the present invention is to provide a fixing device of a satellite navigator, whereby a car charger is connected to a base and a bearing seat is electrically connected with the car charger. Therefore, the satellite navigator can be charged when placed on the bearing seat. Moreover, when one gets off the car and wants to take the satellite navigator with him, he can take the satellite navigator from the bearing seat without detaching the car charger, hence resulting in convenient use.

To achieve the above objects, the present invention proposes a fixing device of a satellite navigator installed in a car. The fixing device of a satellite navigator has a base. A public-address device is disposed in the base. The base is connected to a car charger in a car so that electric power can be provided for the public-address device by the car charger. A supporting arm is disposed on the base. A bearing seat is disposed at the other end of the supporting arm for placement of a satellite navigator. The bearing seat is electrically connected with the car charger device so that the satellite navigator can be charged when placed on the bearing seat. The satellite navigator makes use of the public-address device to give traffic navigation instructions.

### BRIEF DESCRIPTION OF THE DRAWINGS

The various objects and advantages of the present invention will be more readily understood from the following detailed description when read in conjunction with the appended drawing, in which:

FIG. 1 is a perspective view of a fixing device of a car satellite navigator in the prior art;

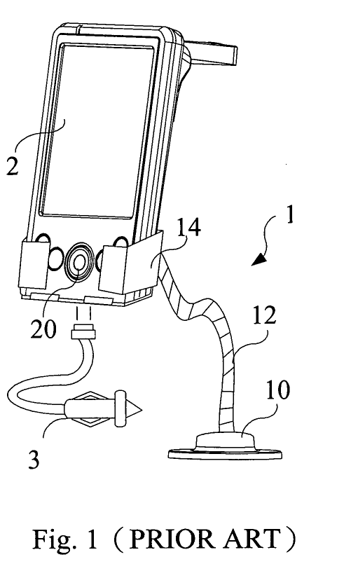

FIG. 2 is a front perspective view of the present invention;

FIG. 3 is a rear perspective view of the present invention;

FIG. 4 is a diagram of a public-address device of the present invention; and

FIG. 5 is a diagram of another embodiment of the present invention.

### DETAILED DESCRIPTION OF THE PREFERRED EMBODIMENTS

In consideration that car satellite navigators gradually replace conventional maps and their more and more importance in people's lives, the present invention proposes a fixing device of a satellite navigator to make the satellite navigators multi-functional and to enhance the convenience in use.

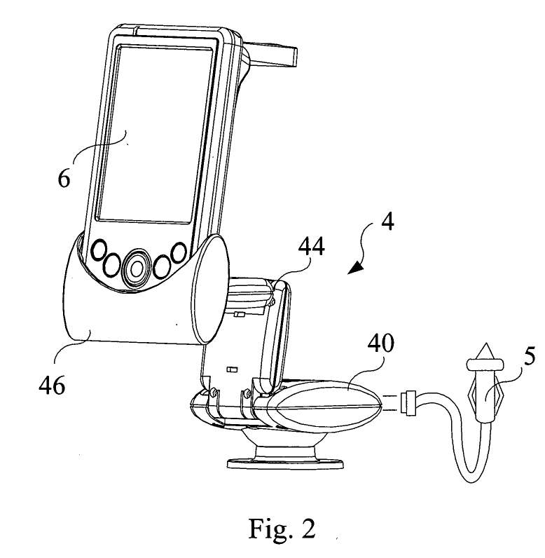

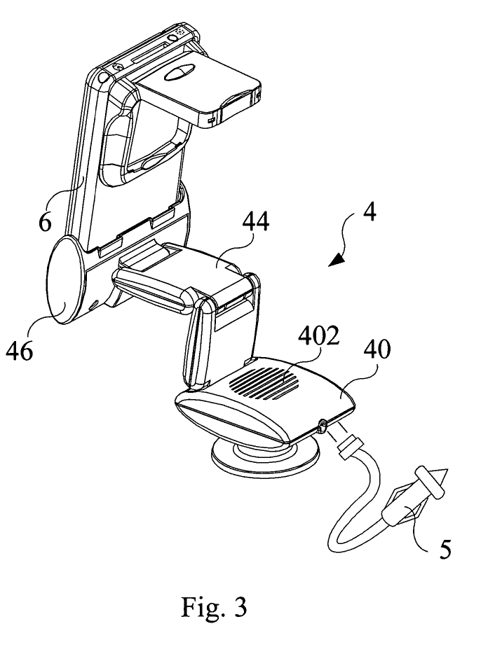

As shown in FIGS. 2 and 3, a fixing device 4 of a satellite navigator has a rotatable base 40. A public-address device 402 is disposed in the base 40. The base 40 is connected to a car charger 5 in a car. Electric power is provided for the public-address device 402 by the car charger 5. A supporting arm 44 is disposed on the base 40. This supporting arm 44 is of segmental design, and can be arbitrarily bent to be fixed at any angle. Besides, a bearing seat 46 is disposed at one end of the supporting arm 44 opposite to the base 40. The bearing seat 46 is used for placement of a satellite navigator 6. The bearing seat 46 is electrically connected with the car charger 5 so that the satellite navigator 6 can be charged when placed on the bearing seat 46. The satellite navigator 6 makes use of the public-address device 402 to give traffic navigation instructions of larger sound.

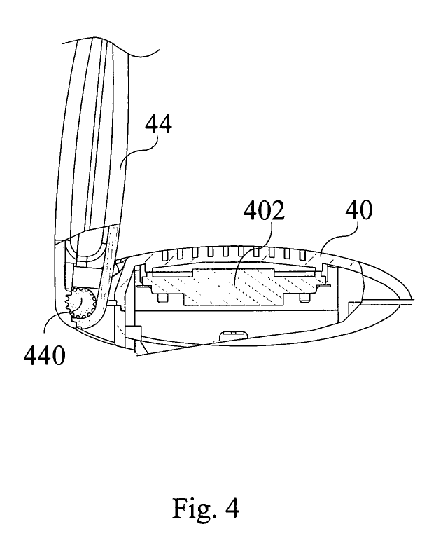

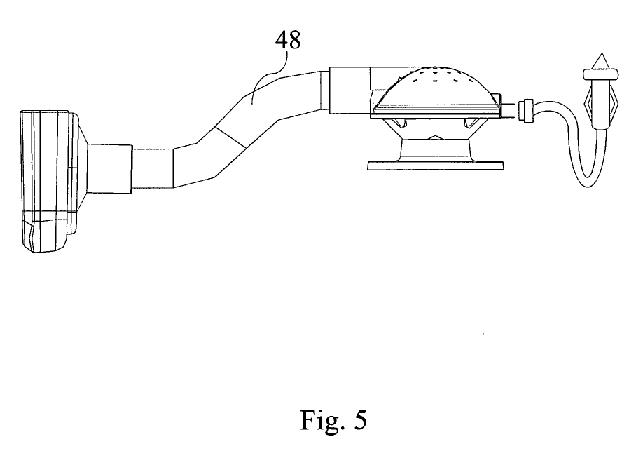

As shown in FIG. 4, the public-address device 402 is disposed in the base 40. The public-address device 402 can be a speaker or a loudspeaker, and can be ant device that can give off larger sound. The supporting arm 44 is disposed on the base 40 by means of a pivot 440 so as to be arbitrarily moved or turned. A shown in FIG. 5, the above supporting arm 44 can also be a snake pipe 48.

Moreover, a display device (not shown) like an LCD is also disposed on the bearing seat 46 to display received messages and statuses of the satellite navigator in real time.

To sum up, the fixing device of a satellite navigator of the present invention has a base with a public-address device disposed therein. The satellite navigator can make use of the public-address device to give traffic navigation instructions so that the problem that the instructions are not heard in a noisy environment can be avoided. Moreover, a supporting arm of segmental design is used for angle adjustment to arbitrarily fix the position of the satellite navigator for convenient viewing of a driver. Furthermore, the base of the fixing device of a satellite navigator is connected to the car charger so that the bearing seat has the same function as a desk charger of mobile phone. When a driver gets off the car and wants to take the satellite navigator with him, he can take the satellite navigator from the bearing seat without detaching the car charger, hence resulting in convenient use.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A fixing device of a satellite navigator installed in a car, said fixing device comprising:
a base having at least a public-address device disposed therein, said base being connected to a car charger in said car so that electric power can be provided for said public-address device by said car charger;
a supporting arm disposed on said base; and
a bearing seat opposite to said base and disposed at the other end of said supporting arm, said bearing seat being used for placement of a satellite navigator, said bearing seat being electrically connected with said car charger so that said satellite navigator can be charged by said car charger, said satellite navigator making use of said public-address device to give voice instructions of traffic navigation.

2. The fixing device of a satellite navigator as claimed in claim 1, wherein said base is rotatable.

3. The fixing device of a satellite navigator as claimed in claim 1, wherein said public-address device is a speaker or a loudspeaker.

4. The fixing device of a satellite navigator as claimed in claim 1, wherein said supporting arm is of segmental design so that said bearing seat can fix said satellite navigator at any place through said supporting arm which can be bent arbitrarily.

5. The fixing device of a satellite navigator as claimed in claim 1, wherein a display device is disposed on said bearing seat to display messages of said satellite navigator in real time.

6. The fixing device of a satellite navigator as claimed in claim 5, wherein said display device is an LCD.
